(19) United States
(12) Patent Application Publication
(10) Pub. No.: US 2025/0028521 A1
(43) Pub. Date: Jan. 23, 2025

(54) IN-VEHICLE DEVICE, PROGRAM, METHOD FOR UPDATING PROGRAM, AND IN-VEHICLE UPDATING SYSTEM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Ken FURUTO, Yokkaichi-shi, Mie (JP); Hiroshi TATEISHI, Yokkaichi-Shi, Mie (JP); Takayuki SHIOZAWA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/715,373

(22) PCT Filed: Nov. 21, 2022
(86) PCT No.: PCT/JP2022/042936

§ 371 Date: May 31, 2024

(30) Foreign Application Priority Data
Dec. 8, 2021 (JP) 2021-199441

(51) Int. Cl. G06F 8/65

(52) U.S. Cl. CPC G06F 8/65

(57) ABSTRACT

An in-vehicle device is an in-vehicle device including a control unit configured to obtain an update program transmitted from an external server outside a vehicle and to perform processing for updating a program of an in-vehicle ECU mounted in the vehicle, wherein the control unit obtains an update program to be applied to the in-vehicle device from the external server, selects, as a substitute ECU, one in-vehicle ECU whose program is not an update target among a plurality of in-vehicle ECUs mounted in the vehicle, and performs activation processing for applying the obtained update program to the in-vehicle device in response to an activation instruction from the selected substitute ECU.

### CROSS-REFERENCE TO RELATED APPLICATIONS

This application is the U.S. national stage of PCT/JP2022/042936 filed on Nov. 21, 2022, which claims priority of Japanese Patent Application No. JP 2021-199441 filed on Dec. 8, 2021, the contents of which are incorporated herein.

### TECHNICAL FIELD

The present disclosure relates to an in-vehicle device, a program, a method for updating a program, and an in-vehicle updating system.

### BACKGROUND

A vehicle is equipped with ECUs (Electronic Control Units) for controlling in-vehicle devices such as devices of a drive control system for engine control and the like, and devices of a body system for air conditioner control and the like. The ECUs each include a computational processing unit such as an MPU, a rewritable nonvolatile storage unit such as an EEPROM, and a communication unit for communicating with other ECUs, and control the in-vehicle devices by loading and executing control programs stored in a storage unit. Furthermore, a communication device having a wireless communication function is mounted in the vehicle, and the vehicle can communicate with a program providing device connected to a network outside the vehicle via the communication device, download (receive) a control program for an ECU from the program providing device, and update the control program of the ECU (for example, see JP 2017-97851A).

The communication device (relay device) disclosed in JP 2017-97851A has a problem in that processing to be performed at the time of updating the control program applied thereto is not considered.

An object of the present disclosure is to provide an in-vehicle device and the like that can efficiently perform processing for updating a program applied to the in-vehicle device, when the in-vehicle device, which performs processing for updating a program of an in-vehicle ECU, performs the program update processing.

### SUMMARY

An in-vehicle device according to an aspect of the present disclosure is an in-vehicle device including a control unit configured to obtain an update program transmitted from an external server outside a vehicle and to perform processing for updating a program of an in-vehicle ECU mounted in the vehicle, wherein the control unit obtains an update program to be applied to the in-vehicle device from the external server, selects, as a substitute ECU, one in-vehicle ECU whose program is not an update target among a plurality of in-vehicle ECUs mounted in the vehicle, and performs activation processing for applying the obtained update program to the in-vehicle device in response to an activation instruction from the selected substitute ECU.

### Advantageous Effects

According to an aspect of the present disclosure, it is possible to provide an in-vehicle device and the like that can efficiently perform processing for updating a program applied to the in-vehicle device, when the in-vehicle device, which performs processing for updating a program of an in-vehicle ECU, performs the program update processing.

### BRIEF DESCRIPTION OF DRAWINGS

FIG. 1 is a schematic view illustrating the configuration of an in-vehicle updating system including an in-vehicle device according to a first embodiment.

FIG. 2 is a block diagram illustrating a physical configuration of the in-vehicle device.

FIG. 3 is a diagram illustrating vehicle configuration information.

FIG. 4 is a diagram illustrating transition in the states of the in-vehicle device, a substitute ECU, an in-vehicle ECU to be updated, and the like in the program update processing.

FIG. 5 is a diagram illustrating a flow (sequence) of processing performed by the in-vehicle device, the substitute ECU, the in-vehicle ECU to be updated, and the like.

FIG. 6 is a flowchart illustrating processing performed by a control unit of the in-vehicle device.

### DETAILED DESCRIPTION OF PREFERRED EMBODIMENTS

First, embodiments of the present disclosure will be listed and described. Note that at least some of the embodiments described below may be combined with each other as appropriate.

An in-vehicle device according to an aspect of the present disclosure is an in-vehicle device including a control unit configured to obtain an update program transmitted from an external server outside a vehicle and to perform processing for updating a program of an in-vehicle ECU mounted in the vehicle, wherein the control unit obtains an update program to be applied to the in-vehicle device from the external server, selects, as a substitute ECU, one in-vehicle ECU whose program is not an update target among a plurality of in-vehicle ECUs mounted in the vehicle, and performs activation processing for applying the obtained update program to the in-vehicle device in response to an activation instruction from the selected substitute ECU.

In this aspect, when the control unit of the in-vehicle device applies the update program to the in-vehicle device itself, the control unit selects an in-vehicle ECU whose program is not a target to be updated as a substitute ECU that performs (transmits) the activation instruction, and thus the processing related to the program update is performed based on the instruction transmitted from the substitute ECU. In other words, the in-vehicle device causes the selected substitute ECU to perform control related to program update (application of an update program, etc.) of the in-vehicle device, and thus, the program update processing of the in-vehicle device is smoothly performed.

In the in-vehicle device according to an aspect of the present disclosure, when a rollback instruction is obtained from the substitute ECU after the control unit performed the activation processing, the control unit may perform rollback processing for returning the program applied to the in-vehicle device to an original program that is a program applied to the in-vehicle device before the update program is applied.

In this aspect, after the control unit of the in-vehicle device performs the activation processing in response to the activation instruction transmitted from the substitute ECU, the substitute ECU performs processing such as operation check (abnormality detection sequence) of the in-vehicle device on which the activation processing has been performed (after the update program has been applied). The substitute ECU transmits (outputs) a rollback instruction to the in-vehicle device when an abnormality is detected in the in-vehicle device on which the activation processing has been performed. The in-vehicle device (control unit) that has obtained the rollback instruction from the substitute ECU performs the rollback processing for returning the program to the original program that is a program applied to the in-vehicle device before the update program is applied, and thus, even when the activation processing fails, the in-vehicle device (control unit) can execute the original program, and can continue the control related to the vehicle.

In the in-vehicle device according to an aspect of the present disclosure, the control unit may obtain, from the external server, an update program to be applied to an in-vehicle ECU whose program is an update target, output the obtained update program for the in-vehicle ECU to the in-vehicle ECU to be updated before performing activation processing on the in-vehicle device, and output an activation instruction for applying the update program for the in-vehicle ECU to the in-vehicle ECU to be updated.

In the present aspect, assuming that the application target of the update program may not only the in-vehicle device, but may also be the in-vehicle device and one or more in-vehicle ECUs, the in-vehicle device obtains the update program to be applied to the in-vehicle device and the one or more in-vehicle ECUs from the external server. The control unit of the in-vehicle device can apply the update program to the one or more in-vehicle ECUs whose program is an update target prior to applying the update program to the in-vehicle device by outputting (transmitting) the update program and the activation instruction to the one or more in-vehicle ECUs before performing the activation processing of the in-vehicle device. That is to say, before the update program is applied, the operation state of the in-vehicle device is relatively stable, and thus the update program can be smoothly applied to the one or more in-vehicle ECUs.

In the in-vehicle device according to an aspect of the present disclosure, the control unit may perform rollback processing in response to a rollback instruction from the substitute ECU, and then output a rollback instruction to the in-vehicle ECU to be updated to return the program applied to the in-vehicle ECU to be updated to the original program that is a program applied thereto before the update program is applied.

In the present aspect, when update programs are respectively applied to the in-vehicle device and the plurality of in-vehicle ECUs, the update programs needs to be respectively applied to all of the in-vehicle device and the in-vehicle ECUs that are the update targets. Accordingly, when the control unit of the in-vehicle device performs the rollback processing of the in-vehicle device in response to the rollback instruction from the substitute ECU, the control unit of the in-vehicle device outputs the rollback instruction to all of the in-vehicle ECUs to be updated after performing the rollback processing, and causes these in-vehicle ECUs to perform the rollback processing. As a result, if the application of the update program to the in-vehicle device fails, the in-vehicle device (control unit) can perform the rollback processing of the in-vehicle device itself based on the instruction transmitted from the substitute ECU, and can perform the rollback processing of the other in-vehicle ECUs to be updated and return the in-vehicle device and the in-vehicle ECUs to be updated to the operation environment before the update program is applied.

In the in-vehicle device according to an aspect of the present disclosure, the control unit performs processing related to an update program in a period in which the vehicle is prohibited from entering an activated state.

In the present aspect, the control unit of the in-vehicle device performs processing related to the update program including the activation processing, the rollback processing, and the like, including selection of the substitute ECU, in a period in which the vehicle is prohibited from entering the activated state, such as a period in which engine start or traction motor drive is prohibited, for example. In the overall processing of the program update, the in-vehicle device (control unit) performs the processing for applying the update program to the in-vehicle ECUs to be updated and the processing for applying the update program to the in-vehicle device based on the instruction transmitted from the substitute ECU in two stages, and thus there is a possibility that a temporary inconsistency (version difference) occurs in the applied programs. Accordingly, the program update processing (processing related to the update program) is performed during the period in which the vehicle is prohibited from entering an activated state, and thus, even when the update program application processing is performed in two stages, the vehicle can be reliably prevented from being activated in a state in which inconsistency occurs in the applied programs.

In the in-vehicle device according to an aspect of the present disclosure, the control unit may specify a plurality of candidate ECUs having a function of the substitute ECU among the plurality of in-vehicle ECUs mounted in the vehicle, and select any one of the plurality of candidate ECUs as the substitute ECU in accordance with a transmission result of the substitution request transmitted to the specified candidate ECUs.

In the present aspect, the vehicle is equipped with a plurality of candidate ECUs having the function of the substitute ECU, and thus, even if any of the candidate ECUs (the in-vehicle ECUs having the function of the substitute ECU) is the target of the program update, another candidate ECU can be selected, and the redundancy in the selection processing of the substitute ECU is improved. The control unit of the in-vehicle device selects the substitute ECU in consideration of the transmission results of the substitution request transmitted to the plurality of candidate ECUs, and, for example, the control unit sequentially transmits the substitution request to the plurality of candidate ECUs based on a predetermined priority order, and selects the candidate ECU that first responds to the substitution request as the substitute ECU. By selecting, as the substitute ECU, the candidate ECU that has responded to the transmission of the substitution request, the reliability of the substitute ECU can be efficiently guaranteed.

The in-vehicle device according to an aspect of the present disclosure further includes a storage unit configured to store vehicle configuration information including information of the in-vehicle ECUs mounted in the vehicle, and the control unit specifies the candidate ECUs by referring to the vehicle configuration information.

In the present aspect, the in-vehicle device (control unit) aggregates information related to all of the in-vehicle ECUs mounted in the vehicle, and stores the aggregated information as the vehicle configuration information in an accessible storage area such as the storage unit included in the in-vehicle device. The vehicle configuration information includes information (candidate ECU flag) indicating, for each of the in-vehicle ECUs, whether or not the in-vehicle ECU has a function of a substitute ECU (suitability as a candidate ECU), and the control unit of the in-vehicle device can efficiently specify the plurality of candidate ECUs by referring to the vehicle configuration information.

In the in-vehicle device according to an aspect of the present disclosure, an in-vehicle network included in the vehicle includes a plurality of segments to which the in-vehicle ECUs are connected, and the control unit selects, as the substitute ECU, an in-vehicle ECU connected to the same segment as a segment to which an in-vehicle ECU whose program is an update target is connected.

In the present aspect, the in-vehicle network mounted in the vehicle is configured by a plurality of segments, and a single or a plurality of in-vehicle ECUs are connected to the plurality of segments. The in-vehicle device includes a plurality of inside-of-vehicle communication units such as CAN transceivers corresponding to the plurality of segments. The control unit of the in-vehicle device selects, as a substitute ECU, an in-vehicle ECU connected to the same segment as a segment to which the in-vehicle ECU to be updated is connected, and deactivates the inside-of-vehicle communication unit corresponding to (connected to) segments to which the in-vehicle ECU to be updated are not connected, such as stopping energization of the inside-of-vehicle communication unit, during a period in which the program update processing is performed. The program update processing needs to be performed during the engine stop period, and thus consumes the power of the power storage device such as a lead battery. Accordingly, by selecting, as the substitute ECU, an in-vehicle ECU connected to the same segment as a segment to which the in-vehicle ECU to be updated is connected, it is possible to stop the energization of the inside-of-vehicle communication units connected to the segments to which the in-vehicle ECU to be updated is not connected, and thus it is possible to reduce the power consumption.

A program according to an aspect of the present disclosure causes a computer configured to obtain an update program transmitted from an external server outside a vehicle and to perform processing for updating a program of an in-vehicle ECU mounted in the vehicle to execute processing for obtaining the update program to be applied to the computer from the external server, selecting, as a substitute ECU, one in-vehicle ECU whose program is not an update target among a plurality for in-vehicle ECUs mounted in the vehicle, and performing activation processing for applying the obtained update program to the computer in response to an activation instruction transmitted from the selected substitute ECU.

In the present aspect, it is possible to provide a program that causes a computer to function as an in-vehicle device configured to efficiently perform processing for updating an applied program when performing the processing for updating the program applied to the in-vehicle device.

A program updating method according to an aspect of the present disclosure causes a computer configured to obtains an update program transmitted from an external server outside a vehicle and that performs processing for updating a program of an in-vehicle ECU mounted in the vehicle to execute processing for obtaining the update program to be applied to the computer from the external server, selecting, as a substitute ECU, one in-vehicle ECU whose program is not an update target among a plurality of in-vehicle ECUs mounted in the vehicle, and performing activation processing for applying the obtained update program to the computer in response to an activation instruction from the selected substitute ECU.

In the present aspect, it is possible to provide an updating method that causes a computer to function as an in-vehicle device configured to efficiently perform processing for updating an applied program when performing the processing for updating the program applied to the in-vehicle device.

An in-vehicle updating system according to an aspect of the present disclosure is an in-vehicle updating system including a plurality of in-vehicle ECUs mounted in a vehicle and an in-vehicle device configured to obtain an update program transmitted from an external server outside a vehicle and to perform processing for updating a program of the in-vehicle ECUs mounted in the vehicle, wherein the in-vehicle device obtains an update program to be applied to the in-vehicle device from the external server, selects one in-vehicle ECU whose program is not an update target among the plurality of in-vehicle ECUs as a substitute ECU, the selected substitute ECU outputs an activation instruction to the in-vehicle device, and the in-vehicle device performs activation processing for applying the obtained update program to the in-vehicle device in response to the activation instruction from the selected substitute ECU.

In the present aspect, it is possible to provide an in-vehicle updating system including an in-vehicle device configured to efficiently perform processing for updating an applied program when performing the processing for updating the program applied to the in-vehicle device.

### Details of Embodiments of the Present Disclosure

The present disclosure will be described in detail with reference to the drawings illustrating embodiments thereof. An in-vehicle device 2 according to the embodiments of the present disclosure will be described below with reference to the drawings. It should be noted that the present disclosure is not limited to these examples, but rather is indicated by the claims and is intended to include all modifications within a meaning and scope equivalent to the claims.

### First Embodiment

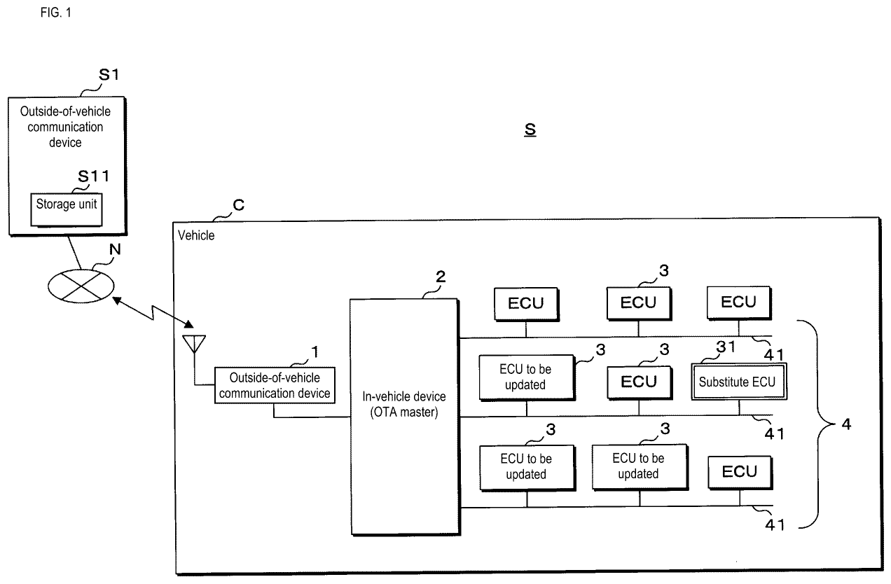

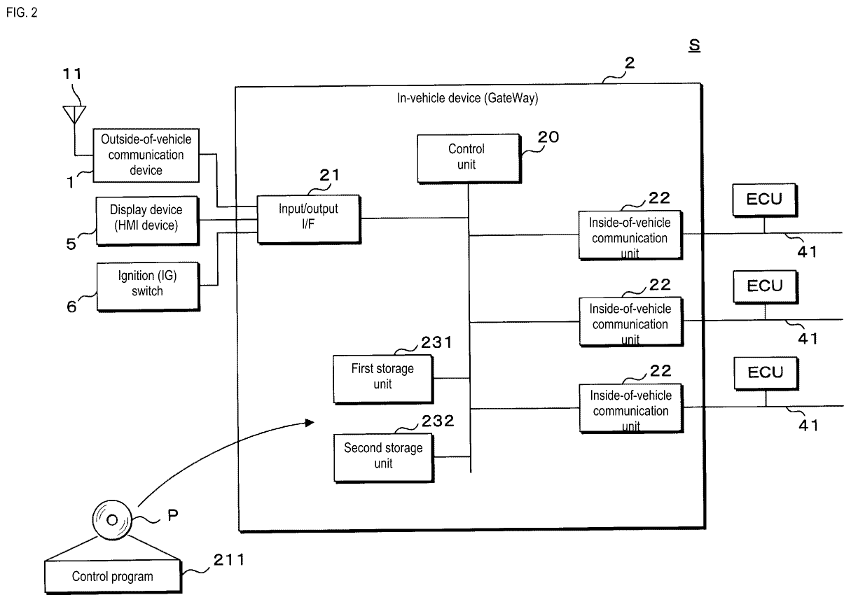

The following describes an embodiment based on the drawings. FIG. 1 is a schematic view showing a configuration of an in-vehicle updating system S according to a first embodiment. FIG. 2 is a block diagram showing a configuration of an in-vehicle device 2. The in-vehicle updating system S includes an outside-of-vehicle communication device 1 and an in-vehicle device 2 that are mounted in a vehicle C, and transmits, to in-vehicle ECUs 3 (Electronic Control Units) mounted in the vehicle C, an update program obtained from an external server S1 (program providing device, OTA server) connected to the in-vehicle updating system S via an external network N.

The external server S1 is a computer such as a server connected to the external network N such as the Internet or a public network, includes a storage unit S11 constituted by a RAM (Random Access Memory), a ROM (Read Only Memory), a hard disk, or the like, and corresponds to an external program providing device located outside the vehicle. A program or data created by the manufacturer or the like of the in-vehicle ECUs 3 for controlling the in-vehicle ECUs 3 is stored in a storage unit S11 of the external server S1. The program or data is transmitted to the vehicle C as an update program, as described later, and used to update the programs or data of the in-vehicle ECUs 3 mounted in the vehicle C. The external server S1 (program providing device) configured as above is also referred to as an OTA (Over The Air) server.

The in-vehicle device 2 functions as an OTA master configured to transmit an update program obtained from the external server S1 to in-vehicle ECUs 3 to be updated, and to transmit an activation instruction for applying the transmitted update program to these in-vehicle ECUs 3. When applying an update program to the in-vehicle device 2 (activation processing) itself, the in-vehicle device 2 functioning as the OTA master selects a substitute ECU 31 described later, and performs activation processing or rollback processing in response to an instruction transmitted from the selected substitute ECU 31. Each of the in-vehicle ECUs 3 mounted in the vehicle C obtains the update program transmitted from the external server S1 by wireless communication via the in-vehicle device 2, and updates (reprograms) the program that the in-vehicle ECU 3 executes, by applying (activating) the update program in response to the activation instruction.

In the following description, the program is assumed to include an external file in which program code including control syntaxes and the like for performing processing by the in-vehicle ECUs 3 and data that is referenced when executing the program code are described. When transmitting the update program, the external file in which the program code and the data are stored is transmitted from the external server S1 as an encoded archive file, for example. When transmitting the update program, the external server S1 creates a package including the update program, and transmits the created package to the vehicle C. The package includes, for example, package information (campaign information) that is information related to program update, information related to the in-vehicle ECU 3s to be updated (target information), and an update program to be applied to these in-vehicle ECUs 3 to be updated.

An outside-of-vehicle communication device 1, the in-vehicle device 2, a display device 5, and the plurality of in-vehicle ECUs 3 for controlling various in-vehicle devices are mounted in the vehicle C. The outside-of-vehicle communication device 1 and the in-vehicle device 2 are communicably connected to each other by a harness such as a serial cable. The in-vehicle device 2 and the in-vehicle ECUs 3 are communicably connected to each other via an in-vehicle network 4 compatible with a communication protocol such as a CAN (Control Area Network) or Ethernet (registered trademark).

The outside-of-vehicle communication device 1 includes an outside-of-vehicle communication unit (not shown) and an input/output I/F (interface) (not shown) for communicating with the in-vehicle device 2. The outside-of-vehicle communication unit is a communication device for performing wireless communication using a mobile communication protocol such as LTE (registered trademark), 4G, 5G, or Wi-Fi (registered trademark), and transmits and receives data to and from the external server S1 via an antenna 11 connected to the outside-of-vehicle communication unit. The communication between the outside-of-vehicle communication device 1 and the external server S1 is performed through an external network N such as a public network or the Internet.

An input/output I/F of the outside-of-vehicle communication device 1 is a communication interface for performing serial communication with the in-vehicle device 2, for example. The outside-of-vehicle communication device 1 and the in-vehicle device 2 communicate with each other through a harness such as a serial cable connected to the input/output I/F. In the present embodiment, the outside-of-vehicle communication device 1 is a device separate from the in-vehicle device 2, and these devices are communicably connected to each other through the input/output I/F and the like, but the present disclosure is not limited to this configuration. The outside-of-vehicle communication device 1 may be built into the in-vehicle device 2 as a constituent part of the in-vehicle device 2. Alternatively, the outside-of-vehicle communication device 1 and the in-vehicle device 2 may be connected to each other via an in-vehicle network 4 such as a CAN.

The in-vehicle device 2 includes a control unit 20, storage units (a first storage unit 231 and a second storage unit 232), an input/output I/F 21, and an inside-of-vehicle communication unit 22. The in-vehicle device 2 is configured to obtain, from the outside-of-vehicle communication device 1, the update program (package) received by the outside-of-vehicle communication device 1 from the external server S1 through wireless communication, and to transmit the update program to predetermined in-vehicle ECUs 3 (in-vehicle ECUs 3 to be updated) through the in-vehicle network 4. In other words, the in-vehicle device 2 functions as an OTA master (reprogramming master) configured to control program update in the in-vehicle ECUs 3 to be updated.

The in-vehicle device 2 is, for example, a gateway (in-vehicle relay device) configured to integrate buses (segments) of a plurality of systems such as in-vehicle ECUs 3 of a control system, in-vehicle ECUs 3 of a safety system, and in-vehicle ECUs 3 of a body system, and to relay communication between the in-vehicle ECUs 3 through these buses (segments). In other words, the plurality of communication lines 41 constituting the plurality of buses (segments) are connected to the in-vehicle device 2, and the in-vehicle network 4 is constituted by the plurality of communication lines 41 (segments) aggregated by the in-vehicle device 2. The in-vehicle device 2 functions as a CAN gateway in the relay performed according to the CAN protocol, and functions as a layer 2 switch or a layer 3 switch in the relay performed according to the TCP/IP protocol. The in-vehicle device 2 may be a PLB (Power Lan Box) that also functions as a power distribution device configured to distribute and relay power that is output from a power supply device such as a secondary battery, and to supply the power to in-vehicle equipment such as actuators connected to the in-vehicle device 2, in addition to relaying power related to communication. Alternatively, the in-vehicle device 2 may also be configured as a functional unit of a body ECU that performs overall control of the vehicle C. Furthermore, the in-vehicle device 2 may also be an integrated ECU that includes a central processing unit such as a vehicle computer, and that performs overall control of the vehicle C.

The control unit 20 is configured, for example, by a CPU (Central Processing Unit), an MPU (Micro Processing Unit), or the like, and performs control processing, arithmetic processing, and the like by loading and executing a control program P (program product) and data stored in advance in a storage unit.

The storage unit is configured by two storage areas of a first storage unit 231 and a second storage unit 232, and each of the first storage unit 231 and the second storage unit 232 is configured by a volatile memory element such as a RAM (Random Access Memory) or a nonvolatile memory element such as a ROM (Read Only Memory), an EEPROM (Electrically Erasable Programmable ROM), or a flash memory. The first storage unit 231 and the second storage unit 232 each store in advance the control program P and data to be referred to while the processing is performed. The control program P is a target to be updated by the update program obtained from the external server S1. The control program P (program product) stored in the storage units (the first storage unit 231 and the second storage unit 232) may be a control program P (program product) that has been read from a recording medium 24 that is readable by the in-vehicle device 2. The control program P may also be downloaded from an external computer (not shown) connected to a communication network (not shown), and stored in the storage unit.

The storage units (the first storage unit 231 and the second storage unit 232) store information on the versions of the two programs (the control program P), that is, the current version and the old version of the programs, and information on the area (active side) in which the program currently executed (applied) is stored. In other words, when the program stored in the first storage unit 231 (first side) is executed in the current state, the first storage unit 231 stores information indicating that the active side is the first storage unit 231 (first side). In this case, information indicating that the second storage unit 232 is an inactive side (second side) is stored. The first storage unit 231, which is the active side, stores the current version of the control program P. The second storage unit 232, which is the inactive side, stores the old version of the control program P. Alternatively, the second storage unit 232, which is the inactive side, may be a storage area in which the old version of the control program P or the like is not stored and may have free capacity. In this manner, because the inactive side is a storage area having free capacity, or because the old version of the control program P or the like is stored in the inactive side, the program to be applied can be returned to the old version by writing the new version of the control program P in the inactive side when the program is updated.

Similarly to the input/output I/F of the outside-of-vehicle communication device 1, an input/output I/F 21 is a communication interface for performing serial communication, for example. The in-vehicle device 2 is communicably connected to the outside-of-vehicle communication device 1, a display device 5, and an ignition (IG) switch 6 via the input/output I/F.

The inside-of-vehicle communication unit 22 is an input/output interface using a communication protocol such as a CAN or Ethernet (registered trademark), and the control unit 20 communicates with in-vehicle apparatuses such as an in-vehicle ECUs 3 or other relay devices that are connected to the in-vehicle network 4 via the inside-of-vehicle communication unit 22. A plurality of (three in the present embodiment) inside-of-vehicle communication units 22 are provided, and communication lines 41 (segments) constituting the in-vehicle network 4 are connected to respective inside-of-vehicle communication units 22. By providing the plurality of inside-of-vehicle communication units 22 in this manner, the in-vehicle network 4 is divided into a plurality of segments, and the in-vehicle ECUs 3 are connected to respective segments according to, for example, the functions (the control system function, the safety system function, and the body system function) of the in-vehicle ECUs 3.

Each of the in-vehicle ECUs 3 includes a control unit, a storage unit, and an inside-of-vehicle communication unit (not illustrated), similarly to the in-vehicle device 2. The storage unit is configured by a volatile memory element such as a RAM (Random Access Memory) or a nonvolatile memory element such as a ROM (Read Only Memory), an EEPROM (Electrically Erasable Programmable ROM), or a flash memory, and stores programs or data of the in-vehicle ECUs 3. The program or data is a target to be updated by an update program transmitted from the program providing device and relayed by the in-vehicle device 2. Similarly to the inside-of-vehicle communication unit of the in-vehicle device 2, the inside-of-vehicle communication unit of the in-vehicle ECU 3 is configured by, for example, a CAN transmitter/receiver or an Ethernet PHY unit, and the in-vehicle ECUs 3 communicate with the in-vehicle device 2 via the inside-of-vehicle communication unit.

Some of the in-vehicle ECUs 3 mounted in the vehicle C have a function for substituting for performing the processing related to the application of the update program in the in-vehicle device 2, that is, have functions of a substitute ECU 31. Although details will be described later, in response to a substitution request transmitted from the in-vehicle device 2, the substitute ECU 31 issues an activation instruction to the in-vehicle device 2, checks the operation of the in-vehicle device 2 after the activation processing has been performed, and issues a rollback instruction if an operation defect is detected.

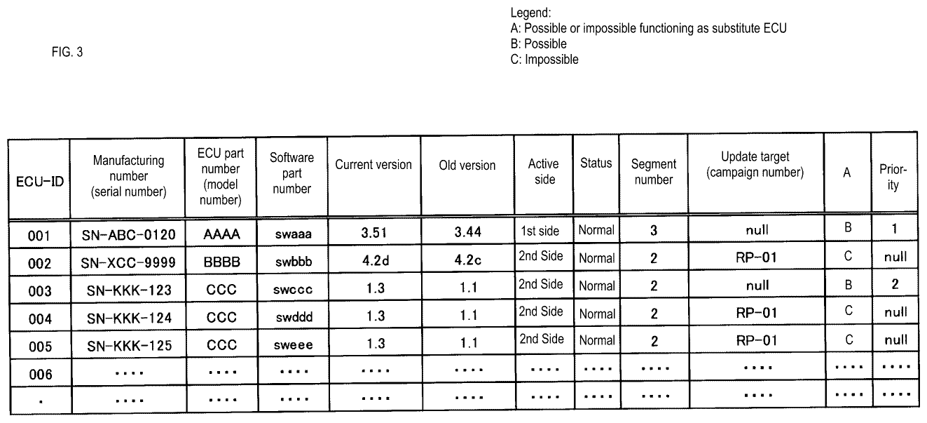

FIG. 3 is a diagram illustrating vehicle configuration information. The in-vehicle device 2 communicates with all of the in-vehicle ECUs 3 mounted in the vehicle C regularly, periodically, or constantly, and obtains information on these in-vehicle ECUs 3. The in-vehicle device 2 requests all of the in-vehicle ECUs 3 or a specific in-vehicle ECU 3 mounted in the vehicle C to transmit the configuration information and the update history of the configuration information regularly, for example, when the ignition (IG) switch 6 is turned ON or OFF, or at a predetermined timing. The in-vehicle device 2 obtains and aggregates the configuration information and the update history transmitted from the in-vehicle ECUs 3, and stores the aggregated configuration information and the update history as vehicle configuration information.

The in-vehicle device 2 may obtain and aggregate the configuration information and the update history transmitted from the in-vehicle ECUs 3 voluntarily without requesting the in-vehicle ECUs 3 to transmit the configuration information and the update history, and store the configuration information and the update history in the storage unit. Alternatively, the in-vehicle device 2 may transmit the update program to the in-vehicle ECUs 3, and change the configuration information (vehicle configuration information) based on the transmitted update program every time the transmission has been completed. The in-vehicle device 2 generates the vehicle configuration information in a table format, for example, by aggregating the information of each of the in-vehicle ECUs 3 obtained from the plurality of in-vehicle ECUs 3, and stores the vehicle configuration information in the storage unit thereof. The storage unit that stores the vehicle configuration information may be the first storage unit 231, the second storage unit 232, or both the first storage unit 231 and the second storage unit 232.

The vehicle configuration information stored in the table format includes, for example, as management items (fields), manufacturing numbers (serial numbers) of the in-vehicle ECUs 3, ECU part numbers (model numbers), software part numbers, current versions of the programs, old versions of the programs, an active side, a status (reprogramming status), segment numbers, update targets (campaign numbers), possible or impossible as a substitute ECU, and the priority, and is managed in association with ECU-IDs by consecutive numbers or the like set so as not to overlap in the in-vehicle ECUs 3. The ECU-ID management items each have an identification number constituted by a number, which is one number of consecutive numbers, for uniquely identifying all of the in-vehicle ECUs 3 mounted in the vehicle C. Furthermore, the vehicle configuration information may include MAC (Media Access Control) addresses and IP addresses of the in-vehicle ECUs 3 as the management items (fields).

The manufacturing numbers (serial numbers) are numbers respectively assigned at the time of manufacturing the in-vehicle ECUs 3, and are each configured by a lot number indicating a production base or the like of the corresponding ECU, consecutive numbers at the time of manufacturing the ECU, and the like, and is a number that can uniquely specify the ECU. The ECU part number (model number) is a number for identifying the type of the in-vehicle ECU 3, and is, for example, a component number. The software part number is a number for identifying the type of software of the update program (the control program P to be updated). The in-vehicle device 2 may identify the in-vehicle ECUs 3 to be updated among the in-vehicle ECUs 3 mounted in the vehicle C, by comparing the serial numbers or the ECU part numbers included in the target information obtained from the external server S1 with the serial numbers or the ECU part numbers included in the vehicle configuration information.

The current version of the program is a version number of the program currently executed by the in-vehicle ECU 3 (applied to the in-vehicle ECU 3), and is a version number of the program stored in the active side. The old version of the program is a version number of a program that was executed by the in-vehicle ECU 3 (applied to the in-vehicle ECU 3), and is a version number of a program stored in the inactive side (storage area that is not the active side). The active side is information for specifying one of the storage areas (a first side that is set in the first storage unit 231 or a second side that is set in the second storage unit 232) in which the program executed by the in-vehicle ECU 3 (applied to the in-vehicle ECU 3) is stored in the present situation. The information regarding to the active side and the version information are stored so as to be used when the new version of the program written at the time of updating is rolled back to the old version of the program.

The management item “status” stores status information (reprogramming status) related to application of the update program in the corresponding in-vehicle ECU 3 (ECU-ID of the same record). The in-vehicle device 2 may communicate with an in-vehicle ECU 3 that is a transmission destination of the activation instruction, obtain status information (reprogramming status) of the in-vehicle ECU 3, and update the status (management item “status”) of each of the in-vehicle ECUs 3. In this manner, the in-vehicle device 2 can aggregate, store, and manage the status information (reprogramming status) of the in-vehicle ECUs 3 after the activation processing has been performed. The in-vehicle device 2 may refer to or update the data at the time of update for installing the new version of a program, at the time of performing activation, and at the time of performing rollback processing. The management item “segment number” stores the number of the communication line 41 (segment) to which the corresponding in-vehicle ECU 3 is connected. The numbers of the communication lines 41 (segments) respectively correspond to the numbers (communication port numbers) of the plurality of inside-of-vehicle communication units 22 included in the in-vehicle device 2. With this configuration, the in-vehicle device 2 can specify the in-vehicle ECUs 3 directly connected to the inside-of-vehicle communication units 22 via the communication lines 41 (segments).

In the management item update target (campaign number, for example, a campaign number is stored for the in-vehicle ECU 3 that is the target of the update (campaign) this time. When group update in which a plurality of in-vehicle ECUs 3 are updated at the same time is performed, for example, it is necessary to determine consistency in a set of versions of the plurality of in-vehicle ECUs 3 to be updated (campaign targets). Accordingly, in all of the in-vehicle ECUs 3 mounted in the vehicle C, the campaign numbers are respectively stored in the fields of the in-vehicle ECUs 3 to be updated (campaign) this time, and therefore, the in-vehicle ECUs 3 to be updated can be efficiently specified. As illustrated in the present embodiment, the fields of the in-vehicle ECUs 3 that are not to be updated may be, for example, blank (a null value is stored). Furthermore, information (ECU part numbers, software versions, etc.) on the plurality of in-vehicle ECUs 3 in which the campaign numbers are stored in the fields to be updated may be extracted and managed in a list in a separate table.

The management item “substitute ECU 31” stores information indicating whether or not the corresponding in-vehicle ECU 3 has a function of a substitute ECU 31 (possible or impossible). In the present embodiment, the in-vehicle ECU 3 for which the management item as a substitute ECU 31 is “possible” is an in-vehicle ECU 3 that can function as a substitute ECU 31, and corresponds to a candidate ECU in the selection of a substitute ECU 31.

The management item “priority” stores priority for selecting a candidate ECU as a substitute ECU 31 when a corresponding in-vehicle ECU 3 is specified as a candidate ECU. The in-vehicle device 2 may sequentially transmit the substitution request to the plurality of specified candidate ECUs based on the priority set in the plurality of candidate ECUs.

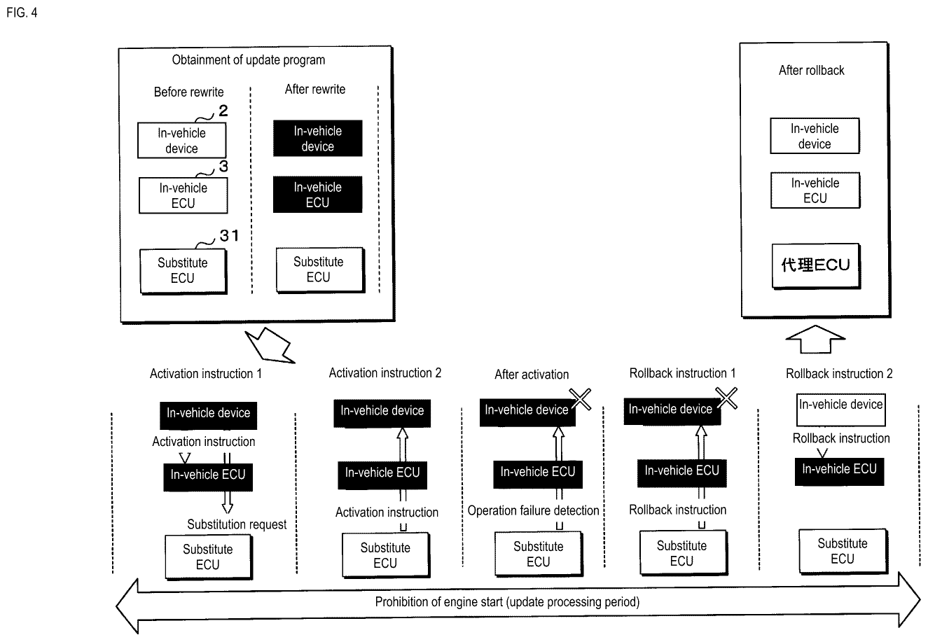

FIG. 4 is a diagram illustrating changes in the state of the in-vehicle device 2, the substitute ECU 31, the in-vehicle ECU 3 to be updated, and the like in the program update processing. For the in-vehicle device 2 and the in-vehicle ECU 3 to be updated, a state before storing the update program and a state after storing the update program are displayed in a reversed display form.

In a state before the update program is stored (before the applied program is rewritten), the in-vehicle device 2 and the in-vehicle ECU 3 execute the control program P stored in the active side. The update program obtained from the external server S1 by the in-vehicle device 2 is stored in the inactive side, and the update program for the in-vehicle ECU 3 is transmitted to the in-vehicle ECU 3, whereby the update program is stored in the inactive side of the in-vehicle device 2 and the in-vehicle ECU 3.

The in-vehicle device 2 transmits a substitution request to an in-vehicle ECU (candidate ECU) that is not an update target and has a function of a substitute ECU 31, and transmits an activation instruction to the in-vehicle ECUs 3 that are update targets. The in-vehicle ECU (candidate ECU) that has responded to the substitution request starts a processing sequence as a substitute ECU 31, and transmits an activation instruction to the in-vehicle device 2. After the activation instruction has been transmitted, the substitute ECU 31 detects whether or not there is an operation defect in the in-vehicle device 2 that has performed the activation processing.

When an operation defect is detected in the in-vehicle device 2 after the activation processing has been performed (operation defect: present), the substitute ECU 31 transmits a rollback instruction to the in-vehicle device 2. The in-vehicle device 2 that has received the rollback instruction from the substitute ECU 31 performs the rollback processing by executing the original program that is the program applied thereto before the update program is applied. The in-vehicle device 2 that performs the rollback processing and executes the original program that is the program applied thereto before the update program is applied transmits a rollback instruction to the in-vehicle ECU 3 to be updated.

The in-vehicle ECU 3 to be updated that has received the rollback instruction from the in-vehicle device 2 performs the rollback processing by executing the original program that is the program applied thereto before the update program is applied. In this manner, the in-vehicle device 2 and the in-vehicle ECU 3 respectively execute the original programs that are the programs applied thereto before the update programs are applied.

As described above, the activation processing and the rollback processing are performed for the in-vehicle device 2 by the substitute ECU 31, and thus the activation processing and the rollback processing are performed in two stages for the in-vehicle device 2 and the in-vehicle ECUs 3 that are the update targets. Accordingly, the series of processing related to the update of the program in the in-vehicle device 2 and the in-vehicle ECUs 3 is performed in a period in which the vehicle C is prohibited from being in the activated state, such as a period in which the engine start or the traction motor drive is prohibited. By performing the processing during the prohibition period, it is possible to prevent the engine from being started in a state where a temporary inconsistency (version difference) occurs in the applied programs. The in-vehicle device 2 may temporarily invalidate the ON signal output from the IG switch 6 via the input/output I/F 21 or the like by performing, for example, masking processing or the like when performing the series of processing related to the update program during a period in which the activation of the vehicle C is prohibited.

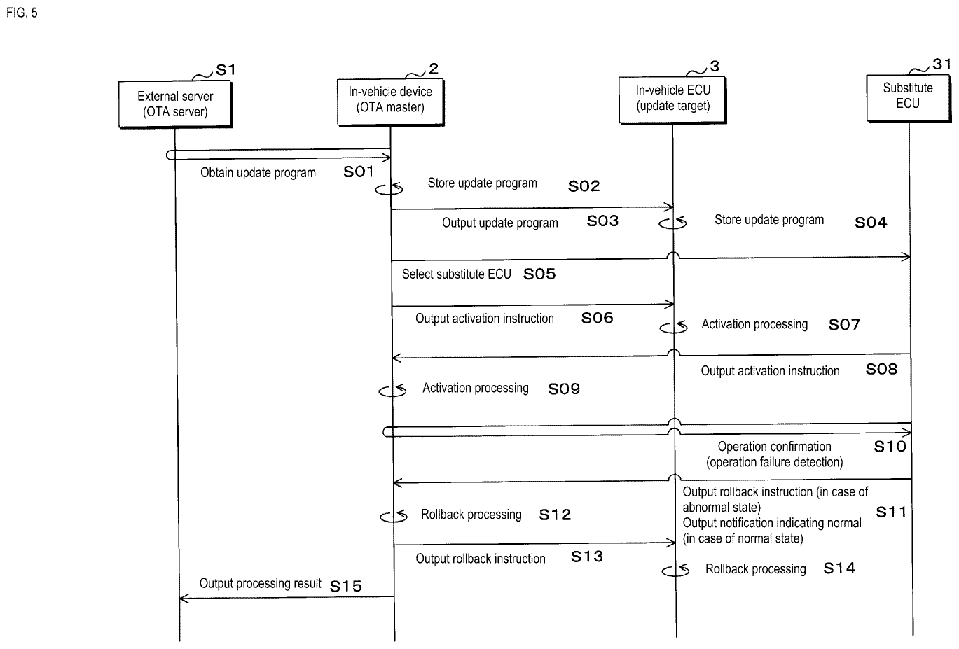

FIG. 5 is a diagram illustrating a flow (sequence) of processing performed by the in-vehicle device 2, the substitute ECU 31, the in-vehicle ECUs 3 to be updated, and the like. The processing sequence performed by each of the external server S1 (OTA server), the in-vehicle device 2 (OTA master), the in-vehicle ECUs 3 to be updated (target ECUs), and the substitute ECU 31 when performing processing related to program update in the in-vehicle device 2 (OTA master) and the in-vehicle ECUs 3 to be updated using the update program will be described.

The in-vehicle device 2 obtains an update program from the external server S1 (S01). The in-vehicle device 2 accesses the external server S1 by using, for example, the identification number (VIN: Vehicle Identification Number) of the vehicle C in which the in-vehicle device 2 is mounted, and obtains the package including the update program applied to the vehicle C from the external server S1. The package includes, for example, package information (campaign information) that is information related to program update, information (target information) related to the in-vehicle device 2 and the in-vehicle ECUs 3 that are update targets, and an update program applied to the in-vehicle device 2 and the in-vehicle ECUs 3 whose programs are to be updated.

The in-vehicle device 2 stores the update program to be applied thereto (S02). The in-vehicle device 2 stores the update program to be applied thereto in a storage area (storage unit) set as an inactive side. The in-vehicle device 2 includes the first storage unit 231 and the second storage unit 232 as storage areas for storing programs, and for example, when a program currently executed is stored in the first storage unit 231, the first storage unit 231 corresponds to the active side. In this case, the previous version (old version) of the program that was executed before the current version of the program is executed is stored as a backup in the second storage unit 232 that is the inactive side. The in-vehicle device 2 stores the update program to be applied thereto that has been obtained from the external server S1 in the second storage unit 232 that is the inactive side. In this manner, the program currently executed can maintain the state of being stored in the first storage unit 231 without being overwritten.

The in-vehicle device 2 outputs (transmits) the update program for the in-vehicle ECUs 3 to be updated to these in-vehicle ECUs 3 (S03). The in-vehicle device 2 specifies the in-vehicle ECUs 3 to be updated based on the target information obtained from the external server S1, and transmits the update program to the specified in-vehicle ECUs 3.

The in-vehicle ECUs 3 to be updated store the update program obtained (received) from the in-vehicle device 2 (S04). Similar to the in-vehicle device 2, each of the in-vehicle ECUs 3 to be updated stores the obtained update program in the inactive side, and thus overwriting of the currently executed program that is stored in the active side can be avoided.

The in-vehicle device 2 transmits a substitution request and selects a substitute ECU 31 (S05). The in-vehicle device 2 specifies a plurality of candidate ECUs that function as a substitute ECU 31, for example, with reference to the vehicle configuration information stored in the storage unit (the first storage unit 231 or the second storage unit 232). The in-vehicle device 2 selects one candidate ECU that is not a target of the program update this time as a substitute ECU 31 from the plurality of specified candidate ECUs. When there are a plurality of candidate ECUs that are not to be updated, the in-vehicle device 2 may sequentially transmit a substitution request (substitution request message) to the plurality of candidate ECUs in a predetermined order of precedence, and may select the candidate ECU that responded to the substitution request first as the substitute ECU 31.

The candidate ECU that has responded to the substitution request from the in-vehicle device 2 starts a processing routine as the substitute ECU 31, for example, with the substitution request as a trigger. In this manner, the substitute ECU 31 functions as an activation instruction unit configured to issue an activation instruction to the in-vehicle device 2, and as an abnormality detection unit and a restoration control unit for the in-vehicle device 2 that has performed the activation processing.

If none of the candidate ECUs responds to the sequentially transmitted substitution request (substitution request message), the in-vehicle device 2 may transmit, to the external server S1, a notification indicating that the application of the update program this time has not been performed because the substitute ECU 31 cannot be specified.

The in-vehicle device 2 outputs (transmits) an activation instruction to the in-vehicle ECUs 3 to be updated (S06). The in-vehicle device 2 outputs an activation instruction to the in-vehicle ECUs 3 to be updated, and causes these in-vehicle ECUs 3 to execute the activation processing.

Each of the in-vehicle ECUs 3 to be updated performs the activation processing in response to the activation instruction output from the in-vehicle device 2 (S07). Each of the in-vehicle ECUs 3 that has obtained (received) the activation instruction output from the in-vehicle device 2 performs the activation processing for applying the update program by restarting the storage area in which the update program is stored, as the active side.

The substitute ECU 31 outputs (transmits) the activation instruction to the in-vehicle device 2 (S08). The in-vehicle device 2 performs the activation processing in response to the activation instruction output from the substitute ECU 31 (S09). The in-vehicle device 2 that has obtained (received) the activation instruction output from the substitute ECU 31 performs the activation processing for applying the update program by restarting the storage area in which the update program is stored and that is set as the activate side.

The substitute ECU 31 performs processing of operation check (operation defect detection) on the in-vehicle device 2 that has performed the activation processing (S10). The substitute ECU 31 (abnormality detection unit) monitors, for example, the presence or absence of a periodic autonomous transmission frame transmitted from the in-vehicle device 2 that has performed the activation processing, determines that the in-vehicle device 2 that has performed the activation processing is normal when the autonomous transmission frame is received, and determines that the in-vehicle device 2 is abnormal (detects an operation defect) when the autonomous transmission frame is not received. Alternatively, the substitute ECU 31 may transmit a test signal for performing the operation defect detection to the in-vehicle device 2 that has performed the activation processing, and may perform the operation check (operation defect detection) of the in-vehicle device 2, based on whether or not a response signal to the test signal has been received from the in-vehicle device 2. In other words, the substitute ECU 31 may determine that the in-vehicle device 2 is normal when the response signal to the test signal is received from the in-vehicle device 2 that has performed the activation processing, and may determine that the in-vehicle device 2 is abnormal (that is, may detect an operation defect) when the response signal is not received from the in-vehicle device 2.

The substitute ECU 31 outputs (transmits) a notification indicating that the operation is normal or a rollback instruction to the in-vehicle device 2 in accordance with the operation check result (S11). When the operation check result is normal, the substitute ECU 31 outputs (transmits) a notification indicating that the operation is normal to the in-vehicle device 2. When the operation check result is abnormal (an operation defect is detected), the substitute ECU 31 (the restoration control unit) outputs (transmits) the rollback instruction to the in-vehicle device 2. The rollback instruction corresponds to a notification indicating an abnormality that indicates that the activation processing (application of the update program) in the in-vehicle device 2 has failed.

The in-vehicle device 2 performs the rollback processing, based on the rollback instruction output from the substitute ECU 31 (S12). The in-vehicle device 2 that has received the rollback instruction output from the substitute ECU 31 performs the rollback processing by restarting the in-vehicle device 2 to execute the program (original program) that was executed before the update program is applied (activation processing). The original program is stored (saved) as a backup in the storage area (inactive side) that is different from the storage area (active side) in which the update program is stored. The in-vehicle device 2 can perform the rollback processing by restarting the storage area in which the original program is stored as the active side and using the storage area in which the update program is stored as the inactive side.

The in-vehicle device 2 outputs (transmits) a rollback instruction to the in-vehicle ECUs 3 to be updated (S13). When the in-vehicle device 2 performs the rollback processing on the in-vehicle device 2 itself, the in-vehicle device 2 outputs a rollback instruction to the in-vehicle ECUs 3 to be updated, and prevents the occurrence of inconsistency due to the difference in the versions of the programs in the in-vehicle device 2 and the in-vehicle ECUs 3.

Even when the in-vehicle device 2 does not perform the rollback processing of the in-vehicle device 2 itself, that is, even when the activation processing on the in-vehicle device 2 is normally terminated, the in-vehicle device 2 outputs (transmits) the rollback instruction to all of the in-vehicle ECUs 3 to be updated when the activation processing fails in any of the in-vehicle ECUs 3 to be updated. In this case, the in-vehicle device 2 further performs the rollback processing on the in-vehicle device 2 itself. In this manner, it is possible to prevent the occurrence of inconsistency due to a difference in program versions or the like in the in-vehicle device 2 and the in-vehicle ECUs 3.

Each of the in-vehicle ECUs 3 to be updated performs the rollback processing in response to the rollback instruction output from the in-vehicle device 2 (S14). Similarly to the in-vehicle device 2, the in-vehicle ECUs 3 to be updated perform the rollback processing for switching the correspondence relationship between the active side in the storage area in which the update program is stored and the inactive side in the storage area in which the original program is stored, restarting the in-vehicle ECUs 3, and returning the in-vehicle ECUs 3 to the environment in which the original program is executed.

The in-vehicle device 2 outputs (transmits) the processing result related to the update program to the external server S1 (S15). The in-vehicle device 2 outputs (transmits), to the external server S1, an update success notification indicating that the application of the update program to the in-vehicle device 2 and the in-vehicle ECUs 3, which are update targets, has succeeded or an update failure notification indicating that the application of the update program has failed and the rollback processing has been performed, as a result of the processing related to the update program. The in-vehicle device 2 may output the result of the processing related to the update program to the display device 5 and cause the display device 5 to display the processing result. The in-vehicle device 2 may correct the vehicle configuration information of the in-vehicle device 2 and the in-vehicle ECUs 3, which are the update targets, based on the result of processing related to the update program.

In the present embodiment, the substitute ECU 31 is substitute for the program update processing on the in-vehicle device 2, but the present disclosure is not limited thereto, and the substitute ECU 31 may be substitute for all of the program update processing on the in-vehicle device 2 and the in-vehicle ECU 3 that are update targets.

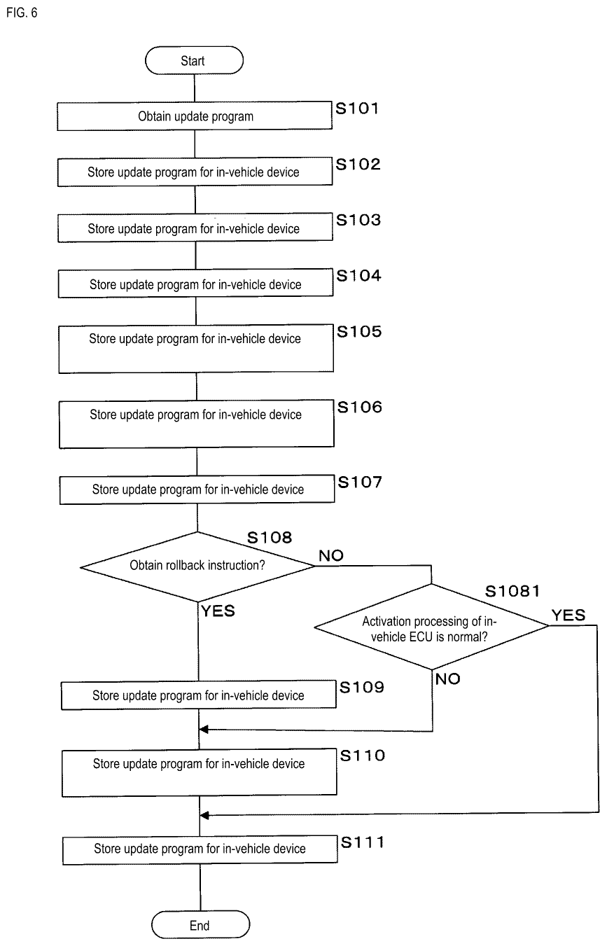

FIG. 6 is a flowchart illustrating the processing of the control unit 20 of the in-vehicle device 2. The control unit 20 of the in-vehicle device 2 constantly performs the following processing, for example, when the vehicle C is in a stopped state, that is, when the IG switch 6 is OFF.

The control unit 20 of the in-vehicle device 2 obtains the update program from the external server S1 (S101). The control unit 20 of the in-vehicle device 2 stores the update program to be applied thereto (S102). The control unit 20 of the in-vehicle device 2 obtains a package including the update programs to be applied to the in-vehicle device 2 and the in-vehicle ECUs 3 from the external server S1, and stores the update programs to be applied thereto in the respective inactive sides of the storage areas. When the first storage unit 231 is the active side and stores the program that is a program currently executed, for example, the control unit 20 of the in-vehicle device 2 stores the update program to be applied thereto in the second storage unit 232 that is the inactive side.

The control unit 20 of the in-vehicle device 2 outputs (transmits), to the in-vehicle ECUs 3 to be updated, the update programs to be applied to these in-vehicle ECUs 3 (S103). The control unit 20 of the in-vehicle device 2 specifies the in-vehicle ECUs 3 to be updated based on the target information included in the package obtained from the external server S1, and transmits, to the specified in-vehicle ECUs 3, the update programs.

The control unit 20 of the in-vehicle device 2 selects a substitute ECU 31 by transmitting a substitution request (S104). The control unit 20 of the in-vehicle device 2 specifies a plurality of candidate ECUs that each function as a substitute ECU 31, which are in-vehicle ECUs 3 that are not targets of program update this time, by referring to vehicle configuration information. The control unit 20 of the in-vehicle device 2 sequentially transmits the substitution request to the plurality of candidate ECUs based on the priority that has been set in the vehicle configuration information, and selects the candidate ECU that first responds to the substitution request as the substitute ECU 31.

When selecting the substitute ECU 31, the control unit 20 of the in-vehicle device 2 may select, as the substitute ECU 31, an in-vehicle ECU 3 that is not an update target and is connected to the same communication line 41 (segment) as the communication line 41 to which the in-vehicle ECU 3 to be updated is connected. The control unit 20 of the in-vehicle device 2 specifies, for example, one or more candidate ECUs that function as a substitute ECU 31 from among the in-vehicle ECUs 3 that are not the update target and are connected to the same communication line 41 (segment) as the communication line to which the in-vehicle ECU 3 to be updated is connected, with reference to the vehicle configuration information. The control unit 20 of the in-vehicle device 2 may transmit a substitution request to the specified candidate ECUs and select the candidate ECU that has responded first as the substitute ECU 31.

In this case, the control unit 20 of the in-vehicle device 2 may stop the power supply to the inside-of-vehicle communication units 22 connected to the communication lines 41 (segments) to which the in-vehicle ECU 3 to be updated is not connected, and reduce the power consumed by the inside-of-vehicle communication units 22. Relays for controlling the supply and interruption of power are provided for the inside-of-vehicle communication units 22 included in the in-vehicle device 2, and the control unit 20 of the in-vehicle device 2 turns OFF the relays. With this configuration, the power supply to the inside-of-vehicle communication units 22 connected to the communication lines 41 (segments) to which the in-vehicle ECU 3 to be updated is not connected may be stopped. Originally, the program update processing consumes electric power of the power storage device such as a lead battery, but the program update processing is performed during the stop period of the engine, and thus the power consumption can be reduced by stopping the energization of the inside-of-vehicle communication units 22.

The control unit 20 of the in-vehicle device 2 outputs (transmits) the activation instruction to the in-vehicle ECUs 3 to be updated (S105). The control unit 20 of the in-vehicle device 2 outputs an activation instruction to the in-vehicle ECUs 3 to be updated, and executes activation processing on these in-vehicle ECUs 3.

The control unit 20 of the in-vehicle device 2 obtains (receives) the activation instruction from the substitute ECU 31 (S106). The control unit 20 of the in-vehicle device 2 performs the activation processing in response to the activation instruction (S107). The control unit 20 of the in-vehicle device 2 executes (applies) the update program by performing the activation processing, and updates the version of the control program P to be executed in the in-vehicle device 2. The control unit 20 of the in-vehicle device 2 executes the update program and, for example, regularly or periodically outputs predetermined data (a frame or a message) through broadcasting or multicasting.

The substitute ECU 31 determines whether or not the predetermined data periodically transmitted from the in-vehicle device 2 that has performed the activation processing, that is, from the in-vehicle device 2 to which the update program is applied, has been received, and determines, based on the determination result, whether or not an operation defect has occurred in the in-vehicle device 2 that has performed the activation processing. Alternatively, the substitute ECU 31 may transmit a test signal to the in-vehicle device 2 that has performed the activation processing, that is, the in-vehicle device 2 to which the update program has been applied, and may determine whether or not an operation defect has occurred in the in-vehicle device 2 that has performed the activation processing, based on whether or not the in-vehicle device 2 responds to the test signal. When it is determined that the in-vehicle device 2 that has performed the activation processing has an operation defect, the substitute ECU 31 outputs (transmits) a rollback instruction to the in-vehicle device 2. When it is determined that the in-vehicle device 2 that has performed the activation processing has no failure in operation, the substitute ECU 31 outputs (transmits) a notification indicating that the in-vehicle device 2 is operating normally.

The control unit 20 of the in-vehicle device 2 determines whether or not the rollback instruction has been obtained (received) from the substitute ECU 31 (S108). When the rollback instruction has been obtained from the substitute ECU 31 (YES in S108), the control unit 20 of the in-vehicle device 2 performs the rollback processing (S109). When the rollback instruction has been obtained from the substitute ECU 31, the control unit 20 of the in-vehicle device 2 restarts the in-vehicle device 2, and performs the rollback processing for executing the program (original program) that was executed before the update program is applied (activation processing).

When the rollback instruction has not been obtained from the substitute ECU 31 (NO in S108), the control unit 20 of the in-vehicle device 2 determines whether or not the activation processing of all of the in-vehicle ECUs 3 to be updated is normally performed (S1081). When the rollback instruction has not been obtained from the substitute ECU 31, the control unit 20 of the in-vehicle device 2 determines that the application of the update program in the in-vehicle device 2 (activation processing) has been normally completed. Alternatively, when a notification indicating that the operation is normal has been obtained from the substitute ECU 31, the control unit 20 of the in-vehicle device 2 may determine that the application of the update program in the in-vehicle device 2 (activation processing) has been normally completed. In this case, the control unit 20 of the in-vehicle device 2 determines whether or not the application (activation processing) of the update program in all of the in-vehicle ECUs 3 to be updated has been normally completed. The control unit 20 of the in-vehicle device 2 may transmit, for example, test communication data to all of the in-vehicle ECUs 3 to be updated, and may determine whether or not the activation processing of the in-vehicle ECUs 3 has been normally completed based on whether response data to the communication data has been received.

When it is determined that the activation processing has not been performed normally for all of the update target in-vehicle ECU 3, that is, when it is determined that the activation processing has not been performed normally for any one of the in-vehicle ECUs 3 to be updated (NO in S1081), or after the in-vehicle device 2 has performed the rollback processing on the in-vehicle device 2 itself (S109), the in-vehicle device 2 outputs (transmits) the rollback instruction to the corresponding in-vehicle ECUs 3 (S110). The corresponding in-vehicle ECUs 3 to be updated perform the rollback processing in response to the rollback instruction output from the in-vehicle device 2.

When it is determined that the activation processing has been normally performed for all of the in-vehicle ECUs 3 to be updated (S1081: YES), or after the in-vehicle device 2 has output the rollback instruction to the in-vehicle ECUs 3 to be updated (S110), the control unit 20 of the in-vehicle device 2 outputs (transmits), to the external server S1, the processing result related to the update program (S111). The control unit 20 of the in-vehicle device 2 may output, to the external server S1 and the display device 5, the processing result related to the update program, and may further correct the in-vehicle device 2 to be updated and the vehicle configuration information related to the in-vehicle ECU 3 based on the processing result.

The embodiments disclosed herein are merely examples in all respects, and should not be construed as limiting the present disclosure. The scope of the present disclosure is defined by the appended claims rather than the foregoing description, and is intended to include all modifications within the scope and meaning equivalent to the appended claims.

1. An in-vehicle device comprising:
a control unit configured to obtain an update program transmitted from an external server outside a vehicle and to perform processing for updating a program of an in-vehicle ECU mounted in the vehicle,
wherein the control unit
obtains an update program to be applied to the in-vehicle device from the external server,
selects, as a substitute ECU, one in-vehicle ECU whose program is not an update target among a plurality of in-vehicle ECUs mounted in the vehicle, and
performs activation processing for applying the obtained update program to the in-vehicle device in response to an activation instruction from the selected substitute ECU.

2. The in-vehicle device according to claim 1,
wherein when a rollback instruction is obtained from the substitute ECU after the control unit performed the activation processing, the control unit performs the rollback processing for returning the program applied to the in-vehicle device to an original program that is a program applied thereto before the update program is applied.

3. The in-vehicle device according to claim 1,
wherein the control unit
obtains, from the external server, an update program to be applied to an in-vehicle ECU whose program is an update target,
outputs the obtained update program for the in-vehicle ECU to the in-vehicle ECU to be updated before performing activation processing of the in-vehicle device, and
outputs an activation instruction for applying the update program for the in-vehicle ECU to the in-vehicle ECU to be updated.

4. The in-vehicle device according to claim 3,
wherein the control unit performs the rollback processing in response to a rollback instruction from the substitute ECU, and then outputs a rollback instruction to the in-vehicle ECU to be updated to return the program applied to the in-vehicle ECU to be updated to the original program that is a program applied thereto before the update program is applied.

5. The in-vehicle device according to claim 1,
wherein the control unit performs processing related to an update program in a period in which the vehicle is prohibited from entering an activated state.

6. The in-vehicle device according to claim 1,
wherein the control unit
specifies a plurality of candidate ECUs having a function of the substitute ECU among the of in-vehicle ECUs mounted in the plurality vehicle, and
selects any one of the plurality of candidate ECUs as the substitute ECU in accordance with a transmission result of the substitution request transmitted to the specified candidate ECUs.

7. The in-vehicle device according to claim 6 further comprising:
a storage unit configured to store vehicle configuration information including information of the in-vehicle ECUs mounted in the vehicle,
wherein the control unit specifies the candidate ECUs by referring to the vehicle configuration information.

8. The in-vehicle device according to claim 1,
wherein an in-vehicle network included in the vehicle includes a plurality of segments to which the in-vehicle ECUs are connected, and
the control unit selects, as the substitute ECU, an in-vehicle ECU connected to the same segment as a segment to which an in-vehicle ECU whose program is an update target is connected.

9. A program that causes a computer configured to obtain an update program transmitted from an external server outside a vehicle and to perform processing for updating a program of an in-vehicle ECU mounted in the vehicle to execute processing for:
obtaining an update program to be applied to the computer from the external server,
selecting, as a substitute ECU, any in-vehicle ECU whose program is not an update target among a plurality of in-vehicle ECUs mounted in the vehicle, and
performing activation processing for applying the obtained update program to the computer in response to an activation instruction from the selected substitute ECU.

10. A method for causing a computer configured to obtains an update program transmitted from an external server outside a vehicle and to perform processing for updating a program of an in-vehicle ECU mounted in the vehicle to execute processing for:
obtaining an update program to be applied to the computer from the external server,
selecting, as a substitute ECU, one in-vehicle ECU whose program is not an update target among a plurality of in-vehicle ECUs mounted in the vehicle, and
performing activation processing for applying the obtained update program to the computer in response to an activation instruction from the selected substitute ECU.

11. An in-vehicle updating system comprising:
a plurality of in-vehicle ECUs mounted in a vehicle; and
an in-vehicle device configured to obtain an update program transmitted from an external server outside a vehicle and to perform processing for updating a program of the in-vehicle ECUs mounted in the vehicle,
wherein the in-vehicle device
obtains an update program to be applied to the in-vehicle device from the external server, and
selects, as a substitute ECU, one in-vehicle ECU whose program is not an update target among the plurality of in-vehicle ECUs, and
the selected substitute ECU outputs an activation instruction to the in-vehicle device, and
the in-vehicle device performs activation processing for applying the obtained update program to the in-vehicle device in response to the activation instruction from the selected substitute ECU.
